(19) United States
(12) Patent Application Publication
(10) Pub. No.: US 2014/0102972 A1
(43) Pub. Date: Apr. 17, 2014

(54) DEVICE FOR FILTERING LIQUIDS

(71) Applicant: Andreas Lueer, Gmunden (AT)

(72) Inventor: Andreas Lueer, Gmunden (AT)

(73) Assignee: Pantreon GmbH, Gmunden (AT)

(21) Appl. No.: 14/125,653

(22) PCT Filed: Dec. 20, 2011
(86) PCT No.: PCT/AT2011/050048

§ 371 Date: Dec. 12, 2013

(30) Foreign Application Priority Data
Jun. 29, 2011 (AT) GM 363/2011

(51) Int. Cl. B01D 33/21

(52) U.S. Cl. CPC B01D 33/21
USPC 210/380.1

(57) ABSTRACT

The invention relates to a device (1) for filtering liquids, comprising at least one rotor (3), which can be driven so as to rotate about a rotational axis (2) and which comprises a supporting device (4) that is fixed to said rotor for disk-shaped filter elements (5) arranged at a distance from the rotational axis (2), the disk surfaces (6) of said filter elements (5) forming the filter surface, wherein a plurality of the filter elements (5) are assembled together into a filter packet on a profiled tube (7) that forms a part of the supporting device (4), for which purpose the filter elements (5) comprise a breakthrough (8) penetrated by the profiled tube (7). In order to provide improved filtering conditions it is proposed that the preferably central disk planes (10) of the filter elements (5) are arranged on the profiled tube (7) in an inclined manner about at least one axis perpendicular to the profiled tube axis (A) in such a way that the disk planes (10) enclose an angle (α, β) with the profiled tube axis (A) that is not equal to 90°.

### FIELD OF THE INVENTION

The invention relates to a device for filtering liquids, comprising at least one rotor, which can be driven so as to rotate about a rotational axis and which comprises a supporting device that is fixed to said rotor for disk-shaped filter elements arranged at a distance from the rotational axis, the disk surfaces of said filter elements forming the filter surface, wherein a plurality of the filter elements are assembled together into a filter packet on a profiled tube that forms a part of the supporting device.

### DESCRIPTION OF THE PRIOR ART

Such known devices (EP 577 854 B1) comprise a rotor as the agitator body, whose agitator elements are formed by tubular filter elements with vertical inflow, a container, devices for introducing a liquid to be filtered into the container, a container outlet for liquid to be discharged in an unfiltered manner from the container, and at least arranged one rotor which can rotatably be driven about the container axis and comprises a hollow shaft mounted in a face-end wall and a carrier device attached thereto for filter elements arranged with a clearance to the vessel axis and rotating around their own axis, the interior of which opens out of the container as a discharge for filtered liquid via the carrier device and the hollow shaft. This prevents or reduces the main problem in the membrane filtration of liquids, namely the formation of covering layers on the membrane surface and the reduction in the effective filter surface caused thereby and the resulting blocking of the membrane pores. These covering layers are usually produced by agglomeration of the solid particles separated in the membrane pores and their concentration in the region of the membrane surface. This effect can be prevented during a continuous filtration process by such devices in such a way that the rotation of the filter elements in the container produces turbulent cross flows and thus shear forces on the membrane surfaces, which cause a continuous mechanical cleaning of the filter elements and produce a continuous swirling of the liquids to be filtered. The invention is to be used in such devices, but it is not limited to the use in such devices.

These devices are suitable for achieving high shear rates and turbulences. The core element is an enclosed filter container in which one or more rotating rings of rotary motors are driven. Starting from tubular or also disk-shaped or similar filter elements (AT 503 567 A), the filtered liquids are collected in the rotor and discharged via the rotor spokes, rotor hub and the hollow shaft from the interior of the container. The filter modules are mounted on said rotor and sealed against high pressures prevailing within the container. However, extreme variations in the overflow conditions, the transmembrane pressure and undesirable shearing or pressure peaks occur over the rotor radius during the rotation of larger horizontally aligned filter areas with a horizontal inflow.

For filtering, the liquid continuously concentrates in the container during operation, since the filtrate/permeate continuously flows off through the filter elements and new liquid is supplied according to the pressure drop. In operation, this type of concentration can be continued until the viscosity of the solution achieves a maximum value by increase in the solids content up to which the flow rate is still economical. The suspension concentrate is then discharged through the container outlet or drained continuously during the operation. In order to allow continuous operation in such devices, it has already been proposed to expand the inner wall of the circumferential container jacket by forming a guide device for the liquid along the container axis towards the container outlet (AT 503 567 A).

### SUMMARY OF THE INVENTION

The invention is based on the object of providing a device of the kind mentioned above which allows improved filter performance by simple means.

This object is achieved by the invention such a way that the preferably central disk planes of the filter elements are arranged on the profiled tube in an inclined manner about at least one axis perpendicular to the profiled tube axis in such a way that the disk planes enclose an angle with the profiled tube axis that is not equal to 90°.

This measure will result in additional improvements in filter performance and with respect to the flow technology of the filter system by tilting the disk-shaped filter elements from a horizontal plane. The filter disks may be inclined in or counter to the direction of rotation. It is also possible to provide a combination of filter elements inclined in the direction of rotation or against the direction of rotation, which are associated with one or several profiled tubes. In addition, there is the possibility of an inclination of the disk planes towards or against the axis of rotation. The inclination of the filter elements causes a spiral flow in a container accommodating the filter packet and thus leads to a flow movement in the vertical direction, which is superimposed on the rotational movement.

In so-called “dynamic membrane processes” the required cross-flow on the filter membrane surface is achieved by movement of the membrane surface by the liquid to be filtered. Despite the turbulence of the flow which is needed for sustained function, a concentration of certain substances near the membrane surface occurs through the size separation effect of membrane pores. This concentration must be compensated for the continuous filtration through constant feeding of and mixing with less contaminated fluid. For dynamic membrane systems with filter elements rotating about one or more axes, there may be an additional concentration in form of density-dependent phase formations as a result of the centrifugal effect of rotation. If the flow through the filter container in which the rotating filter modules are located is not directed longitudinally but frontally to the filter surfaces/filter disks, concentration equilibration can be reduced by supplying the less contaminated liquid. This effect can especially occur in the intermediate spaces of adjacent filter element pairs, i.e. the filter elements which are stacked in form of disks into filter modules.

According to the invention, these filter elements are arranged in an inclined manner on profiled tubes. As a result of the inclination of the filter elements, which are adjusted to the respective rotational direction and velocity and are adapted to the distances between the disks, the flow through the device and the flow around the filter elements can be controlled by freshly supplied fluid or fluid which is remote from the membrane surfaces and thus Less concentrated.

Preferably, the disk planes are inclined against the direction of rotation of the filter elements about an axis which is perpendicular to the profiled tube axis and preferably intersects the rotational axis, and/or is inclined transversely to the direction of rotation. It is possible to set any desired alignment of the inclination with respect to the direction of rotation. Similarly, a separate rotational drive could be provided for the profiled tubes.

Particularly favorable conditions are obtained when the disk planes are arranged in an inclined manner on the profiled tube in relation to a right angle between the disk planes and the profiled tube by 1 to 15°, preferably by up to 6°, especially by 2 to 4°, more preferably by 3°. If the filter elements are arranged to be tilted by about 3°, this may lead to the consequence that the flow is guided to the next higher row of disks of the next filtration module and the flow can thus be guided spirally over the entire row of rotors, which produces an additional circulation effect for the liquid to be filtered in the device. In the following embodiment, the optimum angle of inclination for spiral circulation movement in a container is described by 3°. In fact, however, this optimum of 3°, in which the spiral movement is achieved by filter modules adjacent to the next disk plane, is particularly dependent on the distance of the filter elements to each other in the module and the distance between adjacent modules. The greater the distance between the disks to each other in the module and the smaller the spacing of adjacent modules to each other, the steeper the optimum angle. Different viscosities of liquids may require different distances in the disk module for the efficient achievement of turbulence overflow, which then also leads to a change in the optimum angle of inclination for spiral flow.

Alternatively, the filter elements can comprise annular lugs in the region of the opening which assume the function of spacers between the filter surfaces of adjacent filter elements, whose inner jacket surfaces facing the profiled tube determine the inclination of the filter elements on the profiled tube, or the filter elements are associated with annular spacers in the region of the opening between the filter surfaces whose inner jacket surfaces determine the inclination of the filter elements in the profiled tube. Through these measures, the desired or required inclination of the filter elements on the profiled tubes can be easily set to the desired extent. In order to avoid adjusting the inclination in operation, it is recommended that the filter elements are arranged in a twist-proof manner on the profiled tube.

In accordance with a further development of the invention, at least two rotors are provided, and optionally three or more thereof, which can rotatably be driven about the rotational axis, wherein the filter elements associated with the individual rotors are arranged in an inclined fashion on the profiled tube in such a way that they subject the filtrate to an axially parallel flow component, and wherein the flow component applied to the liquid by the rotor can be directed in the same direction or in the opposite direction. The inclination of the filter elements, especially the filter disks, and their spiral formation over the rotor ring or over the rotor rings which are formed by the filter packets lead to an axial pumping effect for the liquid in the container, depending on the inclination of the filter disks and the direction of rotation. When a filter system is operated with two or more rotor rings, an internal circuit can be formed via the inclination of the filter disks, the directions of rotation of the rotor rings and the pumping effects in two (opposite) directions, even in a closed filter container. In the case of an operation of filter systems with a rotor ring, this internal circuit with a contra-rotating direction of flow to the spiral flow of the rotor can also be achieved in that inner baffles comprised by the rotor and/or outer baffles comprising the rotor are arranged in such a way that they produce a pumping effect in this sense. This can be achieved in such a way that the baffle also has a spiral shape which leads to the desired effect. This baffle or these baffles can optionally be rotatably driven for enhancing the pumping effect. An optimization of the axially parallel pumping effect is possible by forming the baffles in such a way that the intermediate space between the filter disks and the inner wall of the container is reduced (WO2011/120061A).

For the purpose of improving thorough mixture and in order to obtain the best possible homogeneous liquid to be filtered in the filter container, it can be provided in a device arranged in a container that in the region of the two end-faces of the container or in close proximity to the two end-faces of the container at least one respective connecting opening is provided, which at least two connecting openings are flow-connected to each other via a bypass line. The inclination of the filter disks and their spiral formation over the rotor ring or over the rotor rings leads to a pumping effect for the liquid depending on the inclination of the filter disks and the direction of rotation of the rotor or the rotors towards an end-face of the container. Since this process mostly occurs in a closed filter container, a banking-up of the liquid and an increase in the pressure can occur towards one end-face of the container without respective relief measures due to the inclination of the filter disks, the direction of rotation of the rotor ring or the rotor rings and the resulting pumping effect, which prevents a respective concentration exchange. This obstruction of the concentration exchange can be prevented in such a way that the base and cover of the filter container are connected to a bypass line which is dimensioned according to the pumping effect of the spiral flow. This enables a vertical flow in the container.

At least one respective connecting opening can optionally be provided in the region of the two end-faces of the container or in close proximity to both end-faces of the container, wherein the connecting opening on the output side of the one container is connected via a connecting line to the connecting opening of a further container on the input side. Furthermore, there is a possibility to connect at least two containers in series and to connect the connecting opening on the outlet side of the last container in the series via a connecting line to the connecting opening of the first container on the input side. As a result, the filtering performance can thus be increased. In the operation of several filter systems with spiral flow, this external circuit can be arranged in such a way that several installations are connected among each other according to their respective direction of the spiral flow.

It is further recommended for controlling the fluid flow when a fluid flow control valve and/or a feed pump are arranged in the bypass line and/or in the connecting line.

The invention also relates to disk-shaped filter elements which comprise a breakthrough forming a receptacle and their disk surfaces form a filter surface for the aforementioned device. The invention is not limited to the use in said devices however. In the region of the breakthrough, at least one annular protrusion assuming the function of a spacer or a spacer is provided, whose ring axis encloses an angle with a preferably central disk plane which is not equal to 90°, wherein the disk plane is inclined deviating from a right angle between the displaying and the inner ring axis by 1 to 15° for example, preferably by up to 6°, preferably by 2 to 4°, and especially by 3°.

### BRIEF DESCRIPTION OF THE DRAWINGS

The invention is schematically shown by reference to an embodiment shown in the drawings, wherein:

FIG. 1 shows a device in accordance with the invention in a side view;

FIG. 2 shows an enlarged cross-sectional view of a part of the device of FIG. 1;

FIG. 3 shows a constructional variant of the device of FIG. 2;

FIG. 4 shows an enlarged spacer of FIG. 2 in a top view;

FIG. 5 shows a spacer of FIG. 4 in a cross-sectional view;

FIG. 6 shows a constructional variant of the device arranged in the container;

FIG. 7 shows the container with bypass line, and

FIG. 8 shows four containers which are connected in series and which are equipped with a device in accordance with the invention.

### DESCRIPTION OF THE PREFERRED EMBODIMENT

A device 1 for filtering liquids comprises at least one rotor 3 which can rotatably be driven about a rotational axis 2 and comprises a supporting device 4 which is fixed thereto for disk-shaped filter elements 5 which are arranged at a distance from the rotational axis 2 and whose disk surfaces 6 form the filter surface. Filtered liquid is discharged via the interior of the filter elements 5 via the supporting device 4 and the rotor 3 out of the container. A plurality of the filter elements 5 is assembled on a profiled tube 7 into a filter packet, said profiled tube forming a portion of the supporting device 4, for which purpose the filter elements 5 comprise a breakthrough 8 penetrated by the profiled tube 7, which breakthrough 8 forms a receptacle for the profiled tube 7. The interior of the filter and the interior of the profiled tube are flow-connected via boreholes 9 in the profile jacket.

In accordance with the invention, the central disk planes 10 of the filter elements 5 are arranged on the profiled tube 7 in an inclined manner about at least one axis which is vertical to the profiled tube axis in such a way that the disk planes 10 enclose an angle α with the profiled tube axis 7 which is not equal to 90°, wherein the disk planes 10 are preferably inclined against the direction of rotation of the filter elements. It is possible to set any desired alignment of the inclination with respect to the direction of rotation and/or to the rotation radius. Similarly, a separate rotational drive for the profiled tubes 7 could be provided.

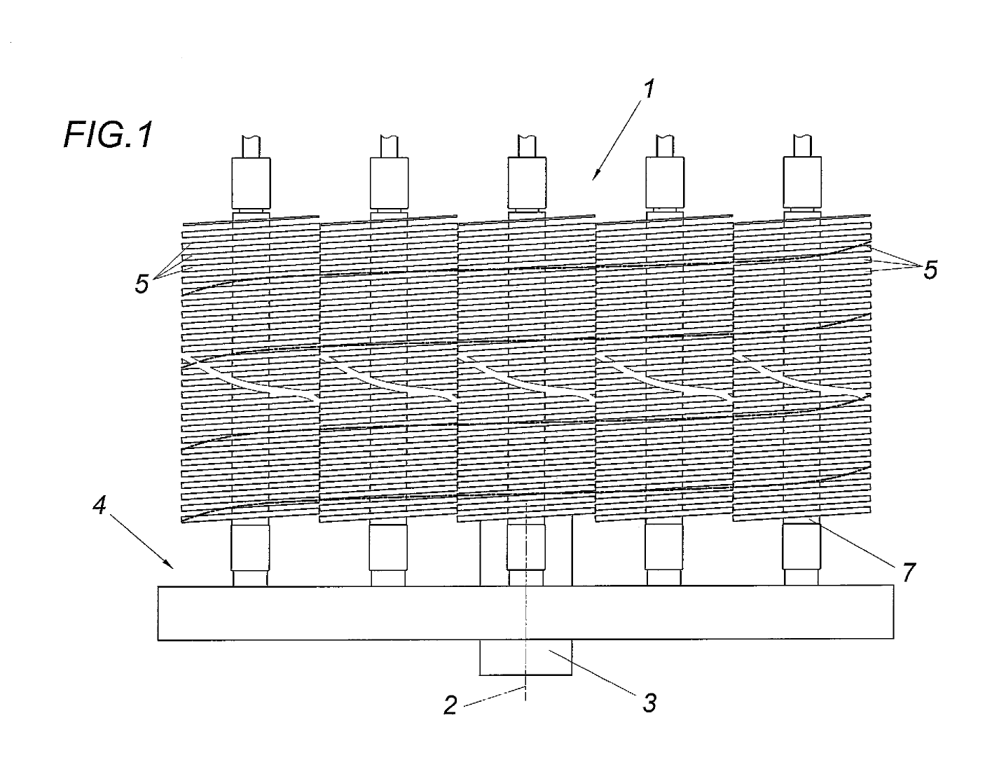

In the illustrated embodiment, the disk planes are arranged in relation to a right angle between the disk planes and the profiled tube inclined by 3° on the profiled tube, and the given angle α is thus 87° and the angle β is 93°. This ensures that the liquid to be filtered is further guided by the flow in the container to the respectively next higher row of disks of the next filter module and consequently the flow can be guided upwardly in a spiral manner over the entire row of rotors, which produces an additional revolving effect for the liquid to be filtered in the device. This effect is indicated in FIG. 1 by the dot-dash helical line.

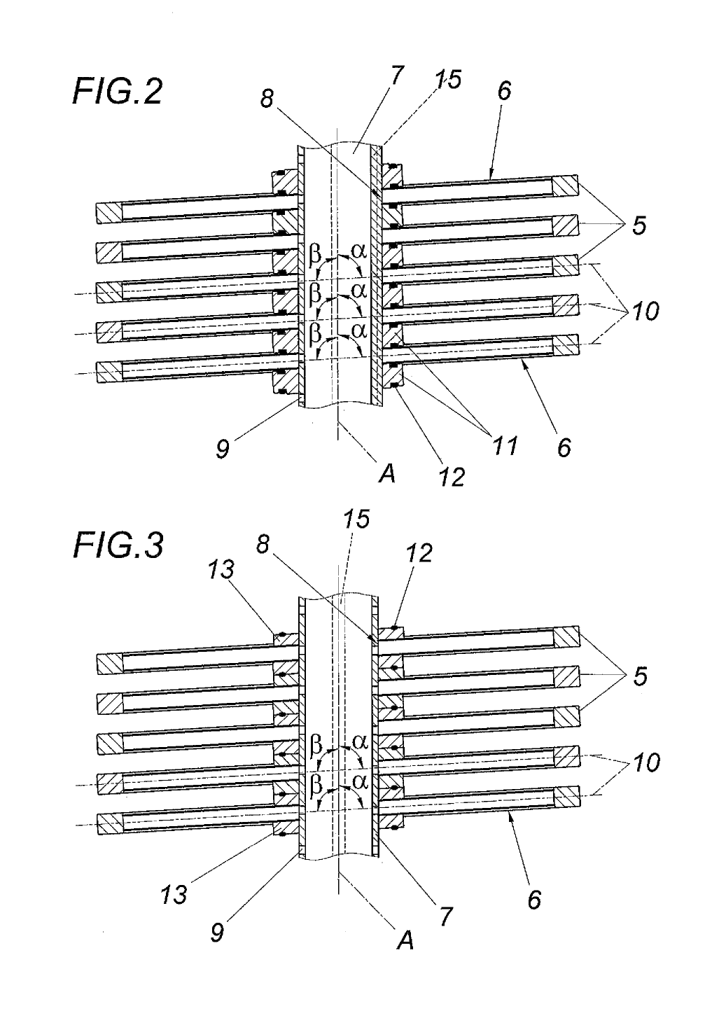

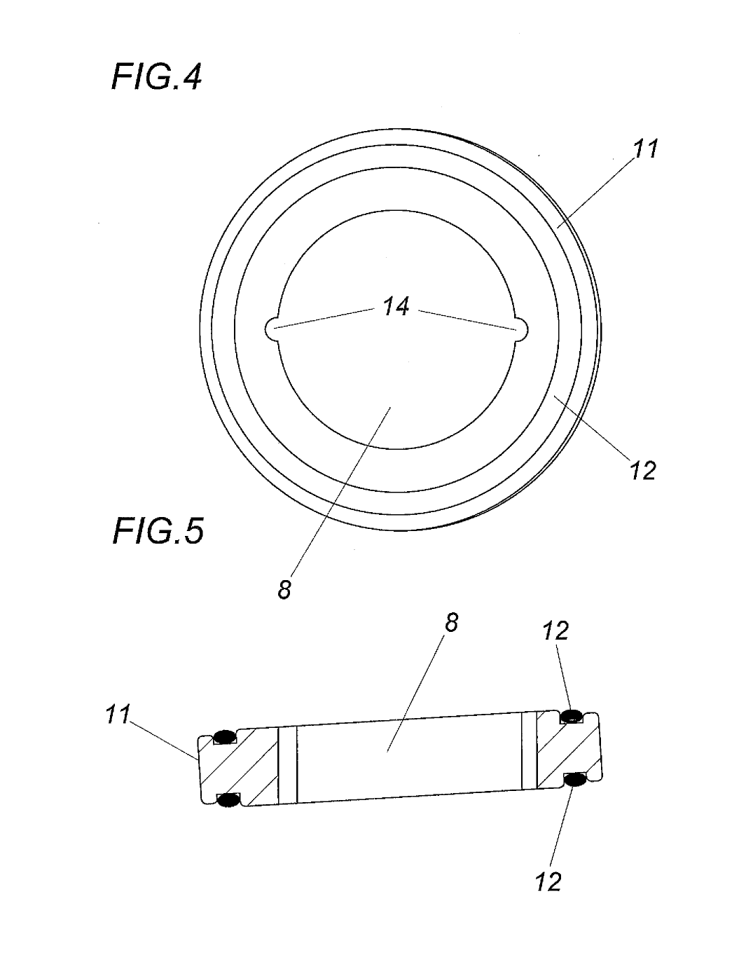

In FIG. 2, annular spacers 11 are assigned to the filter elements 5 in the region of the breakthrough between the filter surfaces 6 of adjacent filter elements 5, whose inner jacket surfaces facing the profiled tube 7 or their ring axes determine the inclination of the filter elements 5 on the profiled tube 7. The spacers are provided on the face side with sealing rings 12. In the embodiment according to FIG. 3, annular protrusions 13 are provided for this purpose, which protrusions 13 form a portion of the filter elements 5 and assume the function of the spacers between the filter surfaces 6 of adjacent filter elements 5, and whose inner jacket surfaces facing the profiled tube 7 or whose ring axes determine the inclination of the filter elements 5 on the profiled tube 7. The decision whether the filter elements 5 are provided with only one protrusion 13 associated with a filter surface 6 or—as in the embodiment—with two protrusions is up to the person skilled in the art. Furthermore, the filter elements 5 are arranged on the profiled tube 7 in a twist-proof manner, for which purpose a groove 14 and spring 15 connection can be provided for example. Other forms of sealing such as bulges, grooves and springs and the like can be provided. The invention is not limited in any way to the illustrated embodiments. Especially useful combinations of the embodiments can be provided at any time.

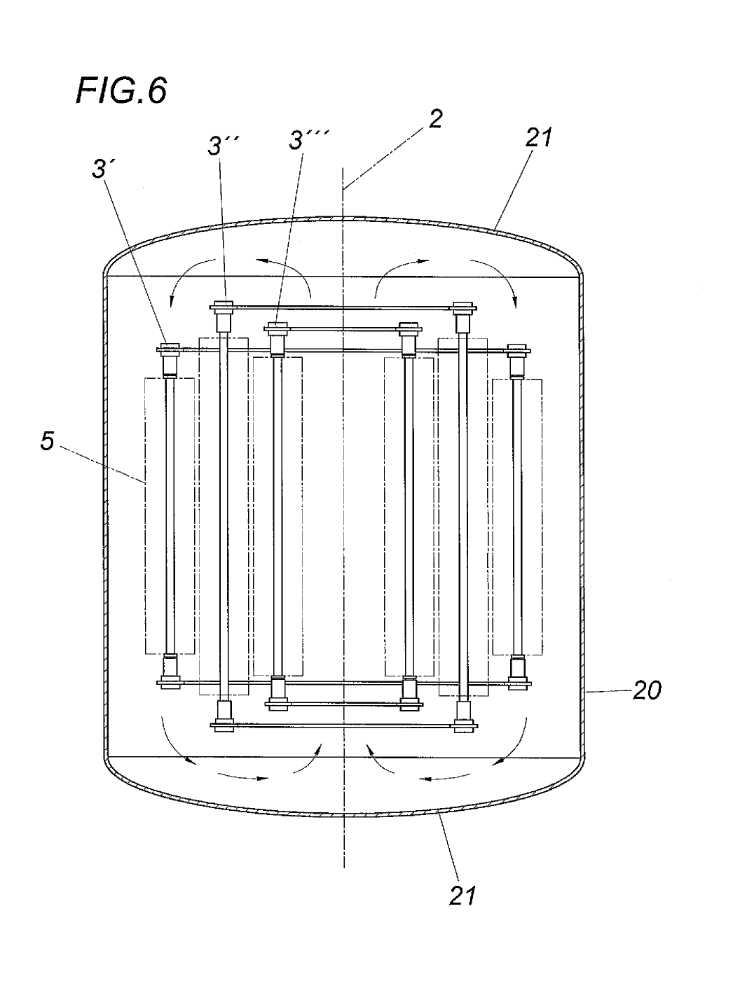

It is advantageous if at least two rotors 3 are provided which can rotatably be driven about the rotational axis 2, wherein the filter element 5 associated with the individual rotors 3 is arranged in an inclined manner on the profiled tube 7 in such a way that they subject the liquid to be filtered to an axially parallel flow component, wherein the flow components applied to the liquid by the rotors 3 can be directed in the same direction or in the opposite direction. In the embodiment according to FIG. 6, the rotors 3, 3′ and 3″ can be driven in any different way as required, namely with different rotational speeds and rotational directions in order to achieve a desired fluid flow in a container 20. The rotor 3′ can be arranged in a static way for example, i.e. as a stator.

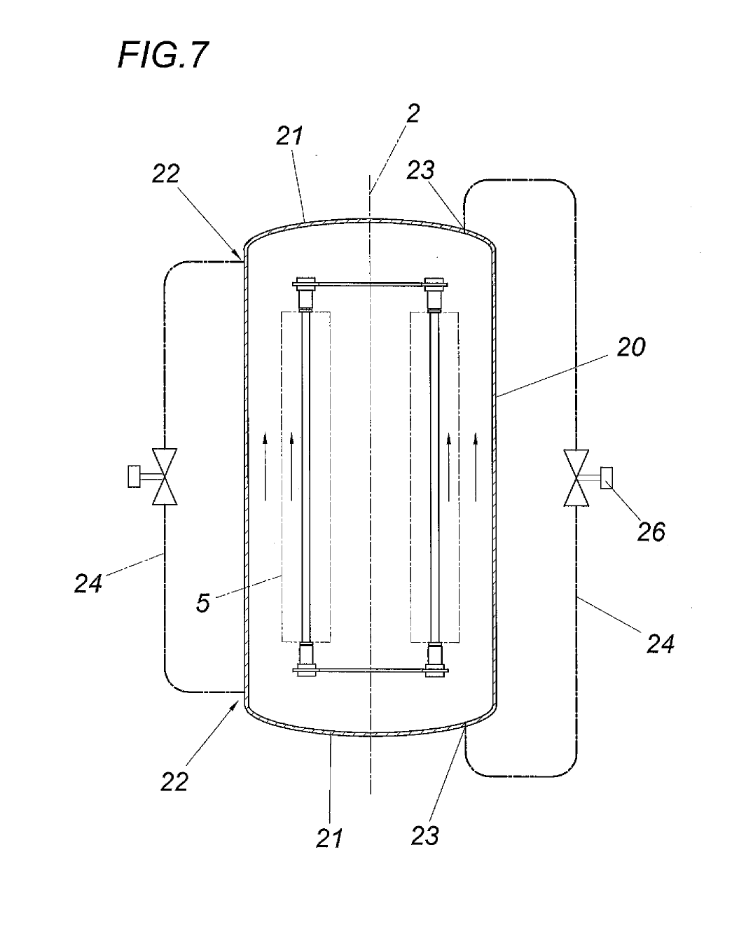

According to the device in accordance with the embodiment according to FIG. 7 as provided in the container 20, at least one respective connecting opening 23 is provided in the region of the two container end-faces 21 or in close proximity to both container end-faces 21 on the circumferential container jacket 22, which at least two connecting openings 23 are flow-connected to each other via a bypass line 24. The choice of the number of the required bypass lines 24 is up to the person skilled in the art, as also the choice of the arrangement of the connecting openings 23, which can be provided in the region of the container end-faces 21 and/or in close proximity to both container end-faces 21. It is therefore also possible that a connecting opening 23 is provided in the region of a container end-surface 21 and the other connecting opening 23 is provided in close proximity to the other container end-face on the circumferential container jacket 22.

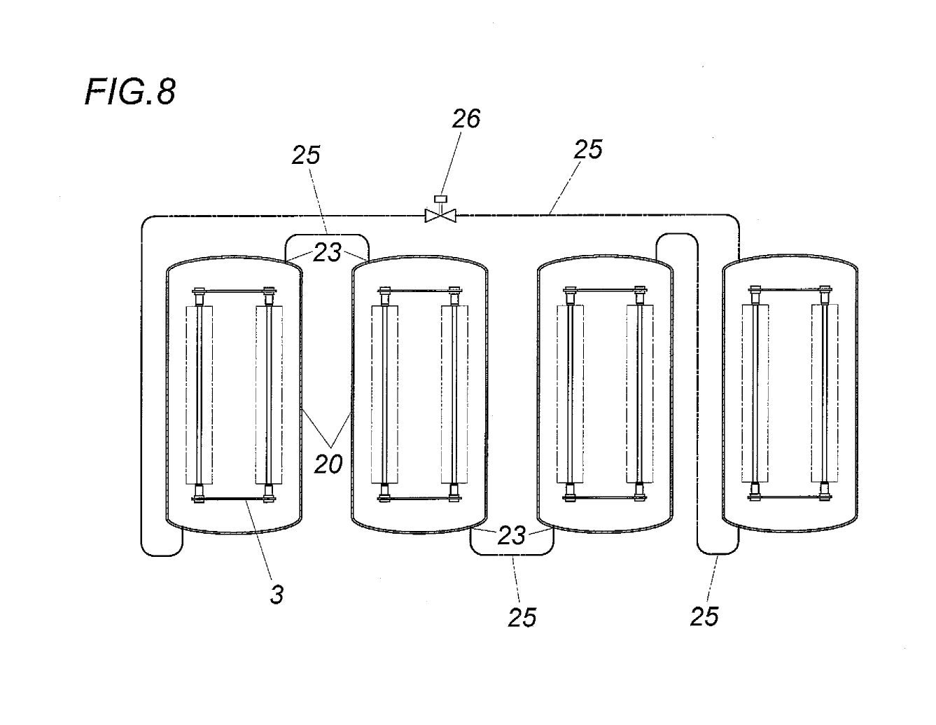

In the device provided in the container according to FIG. 8, at least one respective connecting opening 23 is provided in the region of both container end-faces 21 or in close proximity to both container end-faces 21, wherein the connecting opening 23 on the output side of the one container 20 is connected via a connecting line 25 to the connecting opening 23 on the input side of a further container 20. Four containers 20 are connected in series in FIG. 8, wherein the connecting opening 23 on the outlet side of the container 20 which is the last one in the series is connected via a connecting line 25 to the connecting opening 23 on the input side of the first container 20.

For the purpose of controlling the fluid flow guided via the bypass line 24 and/or the connecting line 25, a fluid flow control valve 26 and/or a feed pump can be arranged in the connecting line 25.

1. A device (1) for filtering liquids, comprising at least one rotor (3), which can be driven so as to rotate about a rotational axis (2) and which comprises a supporting device (4) that is fixed to said rotor for disk-shaped filter elements (5) arranged at a distance from the rotational axis (2), the disk surfaces (6) of said filter elements (5) forming the filter surface, wherein a plurality of the filter elements (5) are assembled together into a filter packet on a profiled tube (7) that forms a part of the supporting device (4), for which purpose the filter elements (5) comprise a breakthrough (8) penetrated by the profiled tube (7), wherein the preferably central disk planes (10) of the filter elements (5) are arranged on the profiled tube (7) in an inclined manner about at least one axis perpendicular to the profiled tube axis (A) in such a way that the disk planes (10) enclose an angle (α, β) with the profiled tube axis (A) that is not equal to 90°.

2. The device according to claim 1, wherein the disk planes (10) are inclined about an axis, which is preferably perpendicular to the profiled tube axis (A) and preferably intersects the rotational axis (2), against the direction of rotation of the filter elements (5) and/or are inclined relative to the rotation radius transversely to the direction of rotation.

3. The device according to claim 1, that wherein the disk planes (10) are arranged in an inclined manner on the profiled tube (7) in relation to a right angle between the disk planes (10) and the profiled tube (7) by 1 to 15°, preferably by up to 6°.

4. The device according to claim 1, wherein the disk planes (10) are arranged in an inclined manner on the profiled tube (7) in relation to a right angle between the disk planes (10) and the profiled tube (7) by 2 to 5°.

5. The device according to claim 1, wherein the disk planes (10) are arranged in an inclined manner on the profiled tube (7) in relation to a right angle between the disk planes (10) and the profiled tube (7) by 3 to 4°.

6. The device according to claim 1, wherein the filter elements (5) comprise annular protrusions (13) in the region of the breakthrough (8), which protrusions assume the function of spacers (11) between the filter surfaces of adjacent filter elements (5) and whose inner jacket surfaces facing the profiled tube (7) determine the inclination of the filter elements (5) on the profiled tube (7).

7. The device according to claim 1, wherein annular spacers (11) are associated with the filter elements (5) in the region of the breakthrough (8) between the filter surfaces of adjacent filter elements (5), whose inner jacket surfaces facing the profiled tube (7) determine the inclination of the filter elements (5) on the profiled tube (7).

8. The device according to claim 1, wherein the filter elements (5) are arranged in a twist-proof manner on the profiled tube (7).

9. The device according to claim 1, wherein at least two rotors (3) are provided which can rotatably be driven about the rotational axis (2), wherein the filter elements (5) associated with the individual rotors are arranged in an inclined manner on the profiled tube (7) in such a way that they apply an axially parallel flow component to a filtrate, wherein the flow components applied by the rotors (3) to a liquid to be filtered can be directed in the same direction or in the opposite direction.

10. The device equipped with a container (20) according to claim 1, wherein at least one respective connecting opening (23) is provided in the region of both container end-faces (21) or in close proximity to both container end-faces (21), which at least two connecting openings (23) are flow-connected to each other via a bypass line (24).

11. The device provided in a container (20) according to claim 1, wherein at least one respective connecting opening (23) is provided in the region of both container end-faces (21) or in close proximity to both container end-faces (21), wherein the connecting opening (23) on the output side of the one container (20) is connected via a connecting line (25) to the connecting opening (23) on the input side of a further container (20).

12. The device according to claim 11, wherein at least two containers (20) are connected in series, and wherein the connecting opening (23) on the output side of the container (20) which is the last one in the series is connected via a connecting line (25) to the connecting opening (23) on the input side of the first container (20).

13. The device according to claim 10, wherein a fluid flow control valve (26) and/or a feed pump are arranged in the bypass line (24) and/or in the connecting line (25).

14. A disk-shaped filter element (5), which comprises a breakthrough (8) forming a receptacle and whose disk surfaces (6) form a filter surface for a device according to claim 1, wherein in the region of the breakthrough (8) at least one annular protrusion (13) assuming the function of a spacer (11) or a spacer (11) is provided, whose ring axis encloses an angle with a preferably central disk plane (10) which is not equal to 90°.

15. The disk-shaped filter element according to claim 14, wherein the disk plane (10) is inclined to deviate from a right angle between the disk plane (10) and the inner ring axis by 1 to 15°, preferably by up to 6°, preferably by 2 to 4°, especially by 3°.
